(19) United States
(12) Patent Application Publication
(10) Pub. No.: US 2012/0004842 A1
(43) Pub. Date: Jan. 5, 2012

(54) PRESENTATION OF A GENERATED ROUTE WITH A SPECIFIABLE ROAD

(75) Inventors: Judith H. Bank, Research Triangle Park, NC (US); Lisa M. Bradley, Research Triangle Park, NC (US); Dana L. Price, Durham, NC (US)

(73) Assignee: INTERNATIONAL BUSINESS MACHINES CORPORATION, Armonk, NY (US)

(21) Appl. No.: 12/828,258

(22) Filed: Jun. 30, 2010

(51) Int. Cl. G01C 21/36; G01S 19/42

(52) U.S. Cl. 701/209; 701/200

(57) ABSTRACT

Embodiments of the present invention provide a method, system and computer program product for presenting a generated route with a specifiable road in a mapping system. In an embodiment of the invention, a method for presenting a generated route with a specifiable road(s) in a mapping system is provided. The method includes receiving an origin and a destination in a mapping application executing in memory by a processor of a computer. The method also includes generating a route in the mapping application from the origin to the destination. Finally the method includes receiving a specified road(s) for the generated route and displaying the generated route and the specified road(s) in a map, wherein the specified road(s) is in a format that distinguishes the specified road(s) from the generated route.

### BACKGROUND OF THE INVENTION

1. Field of the Invention

The present invention relates generally to mapping applications and more particularly to presentation of route generation in mapping systems and computer assisted navigation systems.

2. Description of the Related Art

Software mapping systems often are accessed from over the global Internet through a Web browser. Software mapping systems provide two essential functions. First, software mapping systems generate a map for a location—typically provided in the form of an address. Second, software mapping systems generate a route and corresponding textual directions to one destination from one origination. In many cases, a link embedded in content accessible over the World Wide Web can invoke a remote software mapping system to generate a route to a pre-specified destination associated with the content from a dynamically specified origin. In this way, end users interacting with the content associated with a destination can receive directions to the destination through the content from a dynamically specified origin.

Modern software mapping systems, whether included as part of a computer assisted navigation device, deployed as a stand-alone computer program, or rendered accessible over a network such as the Internet, permit the generation and display of multiple different routes to a specified destination from a specified location. Many times when a user views a generated route map displayed on a global positioning satellite (GPS) enabled navigation device or a mapping device it is difficult to understand where the user is to go as the region/area being displayed may be unfamiliar.

### BRIEF SUMMARY OF THE INVENTION

Embodiments of the present invention provide a method, system and computer program product for presenting a generated route with a specifiable road(s) in a mapping system. In an embodiment of the invention, a method for presenting a generated route with a specifiable road(s) in a mapping system is provided. The method includes receiving an origin and a destination in a mapping application executing in memory by a processor of a computer. The method also includes generating a route in the mapping application from the origin to the destination. Finally the method includes receiving a specified road(s) for the generated route and displaying the generated route and the specified road(s) in a map, wherein the specified road(s) is in a format that distinguishes the specified road(s) from the generated route.

In another embodiment of the invention, a computer mapping system is provided. The system can include a computer with processor and memory, an operating system executing in the computer, a mapping application hosted by the operating system, and a road specification module coupled to the mapping application. The module includes program code enabled to receive a specified road(s) for display with a route from an origin to a destination generated by the mapping application. A global positioning system (GPS) receiver can be included to provide the origin to the mapping application, and as another option, the computer, operating system, mapping application, road specification module and GPS receiver can be included as a single computer assisted navigation device.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for presentation of a generated route with a specifiable road(s) in a computer mapping system;

FIG. 2A is a generated map display at a first zoom level;

FIG. 2B is a generated map display at a second zoom level;

FIG. 2C is a generated map display at a third zoom level;

FIG. 3 is a schematic illustration of a computer mapping system configured for presenting a generated route with a specifiable road(s); and,

FIG. 4 is a flow chart illustrating a process for presenting a generated route with a specifiable road(s) in a mapping system.

### DETAILED DESCRIPTION OF THE INVENTION

Embodiments of the invention provide for presentation of a generated route with a specifiable road(s) in a mapping system. In accordance with an embodiment of the invention, a route can be generated for a specified destination in a mapping system. A specified street can be received by the mapping system. The mapping system can then display the generated route with the specified street in a format that distinguishes the specified road(s) from the route. In one embodiment, the mapping system can provide an end user with a list of suggested roads from which to select the specified road(s). The suggested road(s) could be familiar roads to the user based on past driving history.

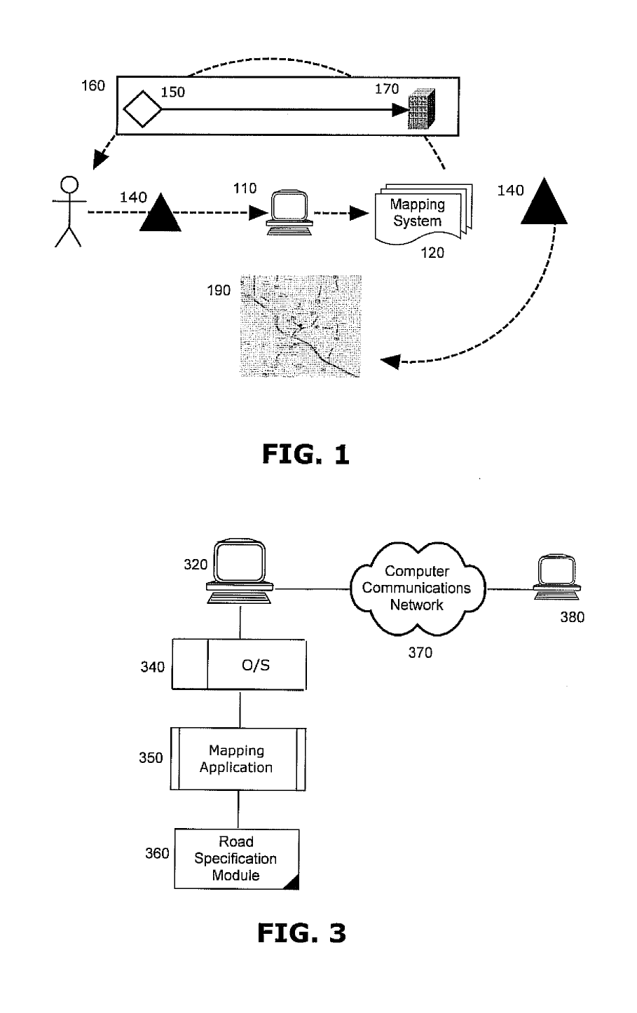

In further illustration, FIG. 1 pictorially illustrates a process for presentation of a generated route with a specifiable road(s) in a computer mapping system. As shown in FIG. 1, software mapping system 120 of a computer mapping system 110 configured for presenting a generated route with one or more specifiable roads 140 can generate an initial route 160 based upon a received origin 150 and destination 170. Optionally, the origin 150 can be computed through GPS locator (not shown). The route 160 can be provided to the end user 180 for review and one or more specified roads 140 can be returned to the mapping system 120. In this regard, the specified road(s) 140 can be provided by the end user 180, by a third party familiar with the destination 170 or the mapping system can provide an end user with a list of suggested roads from which to select the specified road(s). In any case, the specified road(s) 140 is to be presented with the generated route in a map 190 for display to the end user 180.

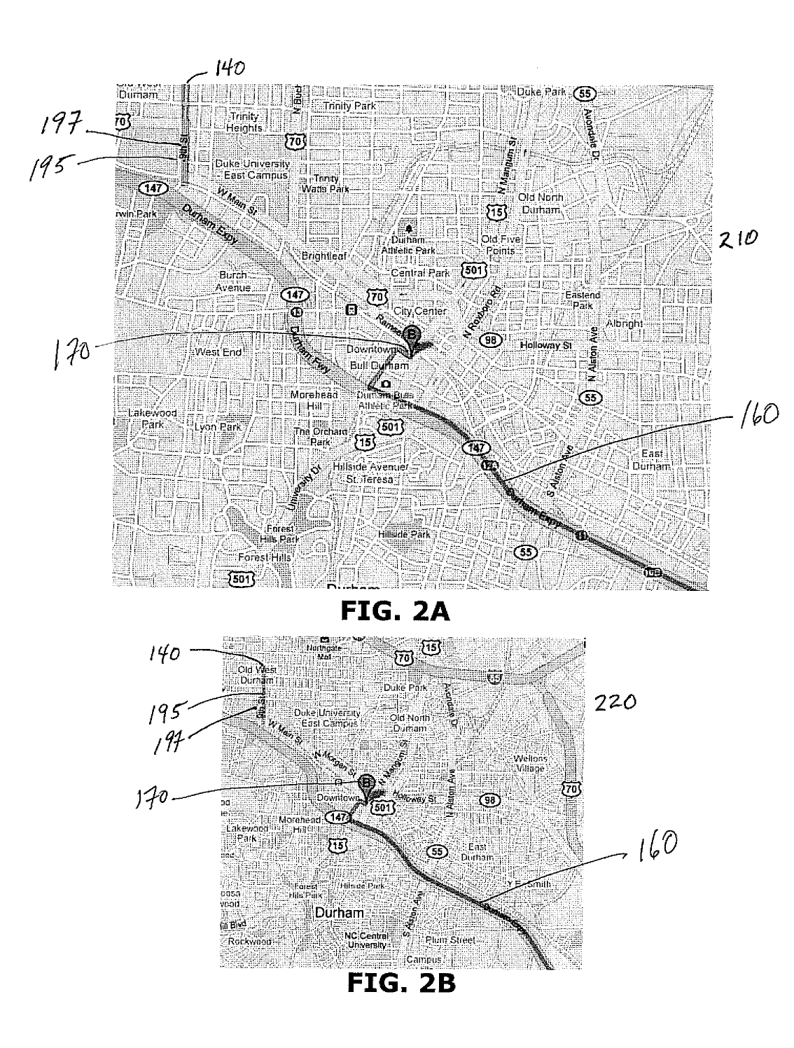

In further illustration, FIGS. 2A through 2C illustrate generated maps 210, 220 and 230 at three different zoom levels. Typically, only those streets that are shown near the generated route are in the “zoom locus” of the map and thus presented to the end user 180. In the present invention, the specifiable road(s) 140 can be presented in a format that distinguishes the specified road(s) from the route regardless of the zoom level. In one embodiment, the specifiable road(s) 140 can be distinguished from the generated route 160 in a variety of ways, including, but not limited to, using highlighting, labeling, different colors, line thicknesses and line styles. For example, in FIGS. 2A and 2B, the specified road 140 is both highlighted 195 and labeled 197 in the generated route maps 210 and 220. In FIG. 2C, the specified road 140 is only highlighted 195. Regardless of the fact that the specified road 140 in not in the zoom locus of the generated route of FIG. 2C, the specified road 140 remains visible to the end user 180 whenever the generated route map 230 is presented.

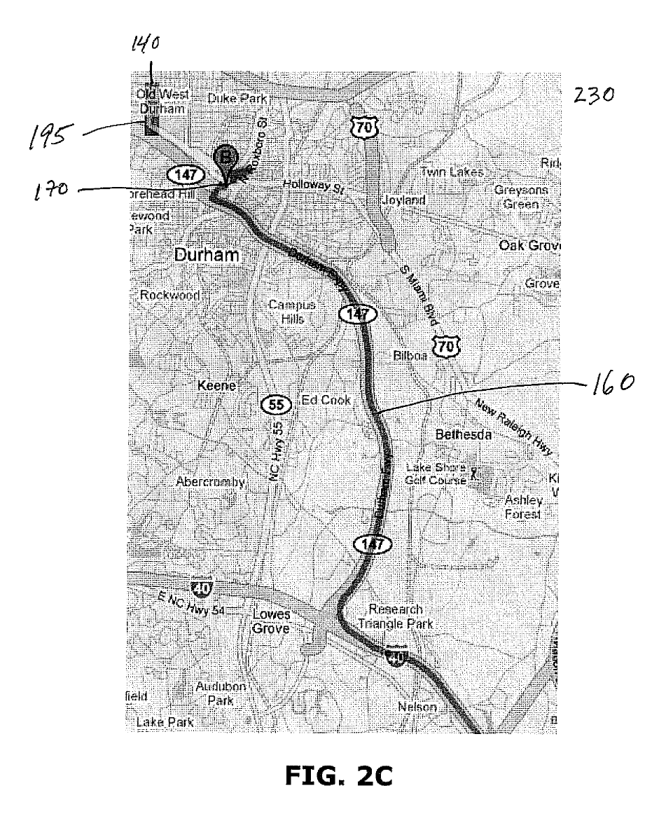

The process described in connection with FIG. 1 can be implemented in a mapping system or a computer assisted navigation system. In yet further illustration, FIG. 3 schematically shows a computer mapping system configured for presenting a generated route with one or more specifiable road(s). The system can include a general purpose computer configured with a mapping system. By way of example, the system can include a computer 320 with processor and memory supporting the execution of an operating system 340 hosting the operation of a mapping application 350. The mapping application 350 can be configured to generate routes between an origin and a specified destination as provided by an end user. Further, the mapping application 350 can be configured when coupled to a GPS receiver (not shown) to generate the different alternative routes between an origin determined by the GPS receiver and a specified destination.

Of note, a road specification module 360 can be coupled to the mapping application 350 and can execute in the memory of the computer 320. Alternatively, the road specification module 360 can execute in the memory of a different computer (not shown), but can be communicatively linked to the mapping application 350. The road specification module 360 can include program code that when executed by the processor of the computer 320 (or any other computer) can receive a specified road(s) 140 for a generated route 160 and can present the specified road(s) 140 with the generated route map 190 to an end user 180.

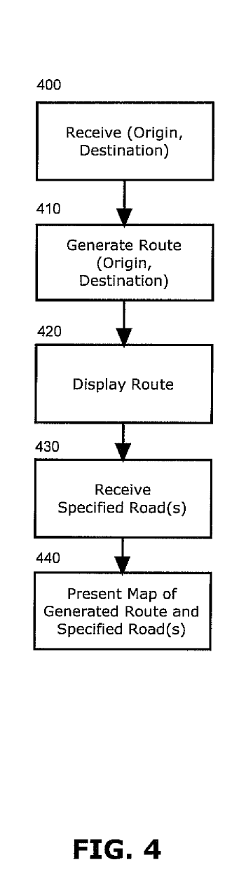

In even yet further illustration of the operation of the road specification module 360, FIG. 4 is a flow chart illustrating a process for presenting a generated route with a specifiable road(s) in a mapping system. Beginning in block 400, an origin and destination can be received and in block 410, a route can be generated for the origin and destination. In block 420, the route can be displayed through a user interface such as a Web browser or that of a GPS navigation device. In block 430, at least one specified road (and optionally multiple specified roads) can be received and in block 440, a map of the generated route and the specified road(s) can be presented to a user.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for presenting a generated route with a specifiable road in a mapping system, the method comprising:
receiving an origin and a destination in a mapping application executing in memory by a processor of a computer;
generating a route in the mapping application from the origin to the destination;
receiving a specified road for the generated route; and,
displaying the generated route and the specified road in a map, wherein the specified road is in a format that distinguishes the specified road from the generated route.

2. The method of claim 1, wherein the format is highlighting of the specified road in a color different from the generated route.

3. The method of claim 1, wherein the specified road remains highlighted in the map as the level of zoom is changed.

4. The method of claim 1, wherein receiving an origin comprises receiving the origin from a global positioning system (GPS) navigation device.

5. The method of claim 1, wherein receiving the specified road for the generated route comprises receiving the specified road from an end user associated with the destination from over a computer communications network.

6. The method of claim 1, wherein receiving an origin and a destination in a mapping application includes prompting a user to enter the origin and the destination.

7. The method of claim 1, wherein at least two specified roads are displayed in the map.

8. The method of claim 1, further comprising providing an end user with a list of suggested roads from which to select the specified road.

9. A computer mapping system comprising:
a computer with processor and memory;
an operating system executing in the computer;
a mapping application hosted by the operating system; and,
a road specification module coupled to the mapping application, the module comprising program code enabled to receive a specified road for display with a route from an origin to a destination generated by the mapping application.

10. The system of claim 9, further comprising a global positioning system (GPS) receiver providing the origin to the mapping application.

11. The system of claim 9, wherein the computer, operating system, mapping application, road specification module and GPS receiver are included as a single computer assisted navigation device.

12. A computer program product comprising a computer usable medium embodying computer usable program code for presenting a generated route with a specifiable road in a mapping system, the computer program product comprising:
computer usable program code for receiving an origin and a destination in a mapping application executing in memory by a processor of a computer;
computer usable program code for generating a route in the mapping application from the origin to the destination;
computer usable program code for receiving a specified road for the generated route; and,
computer usable program code for displaying the generated route and the specified road in a map, wherein the specified road is in a format that distinguishes the specified road from the generated route.

13. The computer program product of claim 12, wherein the computer usable program code for the format comprises computer usable code for highlighting of the specified road in a color different from the generated route.

14. The computer program product of claim 13, wherein the computer usable program code for highlighting of the specified road comprises computer usable program code for keeping the specified road highlighted in the map as the level of zoom is changed.

15. The computer program product of claim 12, wherein the computer usable program code for receiving an origin comprises computer usable program code for receiving the origin from a global positioning system (GPS) navigation device.

16. The computer program product of claim 12, wherein the computer usable program code for receiving the specified road for the generated route comprises computer usable program code for receiving the specified road from an end user from over a computer communications network.

17. The computer program product of claim 12, wherein the computer usable program code for receiving an origin and a destination in a mapping application comprises computer usable program code for receiving the specified road from an end user associated with the destination from over a computer communications network.

18. The computer program product of claim 12, wherein the computer usable program code for receiving an origin and a destination in a mapping application comprises computer usable program code for prompting a user to enter the origin and the destination.

19. The computer program product of claim 12, wherein the computer usable program code for generating the route comprises computer usable program code for displaying at least two specified roads in the map.

20. The computer program product of claim 12, further comprising computer usable program code for providing an end user with a list of suggested roads from which to select the specified road.
